(19) United States
(12) Patent Application Publication
(10) Pub. No.: US 2017/0091668 A1
(43) Pub. Date: Mar. 30, 2017

(54) SYSTEM AND METHOD FOR NETWORK BANDWIDTH AWARE DISTRIBUTED LEARNING

(71) Applicant: NEC Laboratories America, Inc., Princeton, NJ (US)

(72) Inventors: Asim Kadav, Franklin Park, NJ (US); Erik Kruus, Hillsborough, NJ (US)

(73) Assignee: NEC Laboratories America, Inc., Princeton, NJ (US)

(21) Appl. No.: 15/220,682

(22) Filed: Jul. 27, 2016

Related U.S. Application Data
(60) Provisional application No. 62/234,916, filed on Sep. 30, 2015.

(51) Int. Cl. G06N 99/00; H04L 29/08

(52) U.S. Cl. CPC G06N 99/005; H04L 67/10

(57) ABSTRACT

A machine learning method includes connecting machines in a data-center using a network aware model consistency for stochastic applications; ensuring a communication graph of all machines in the data-center is connected; propagating all updates uniformly across the cluster without update; and preferring connections to a machine with first network throughput over machines with second network throughput smaller than the first network throughput.

This application claims priority to Provisional Application Ser. No. 62/234,916 filed Sep. 30, 2015, the content of which is incorporated by reference.

### BACKGROUND

The present invention relates to distributed learning.

Machine learning (ML) model replicas split their data and train in parallel. Periodically, these machines send out model information to all other replicas. This is important for two reasons. First, to ensure that all models learn from all data and second, frequent communication ensures that the models are always being updated to converge towards a global minimum. Hence, in an all-reduce style parallel model-training, all machines may send model information to one-another.

However, as long as all machines are connected and all model information are spread uniformly across the cluster. Relaxed consistency results in faster model training times since models need to synchronize fewer incoming model updates and the network communication costs are reduced. Conventional systems have used the “parameter server” communication graph. Here all machines communicate with a central parameter server and send/receive model information. However, this style of communication is oblivious to network speeds. If the model replicas are connected naively without any regards to network throughput speeds, there can be excessive cross-datacenter traffic, and slower training speeds since more epochs are required to incorporate effect of all data.

### SUMMARY

In one aspect, a machine learning method includes connecting machines in a data-center using a network aware model consistency for stochastic applications; ensuring a communication graph of all machines in the data-center is connected; propagating all updates uniformly across the cluster without update; and first preferring connections to a machine with higher network throughput over machines with second, lower network throughput than the first network throughput.

Advantages of the preferred embodiments may include one or more of the following. The system takes into consideration network latency or speeds between the attached machines. The system works with a partial version of all-reduce based primitives, where machines may communicate with fewer machines to limit communication costs while considering network throughput. We call this as sparse-reduce primitive, where machines may perform reduce with fewer machines while ensuring that the network graph of machines remains connected. Balancing CPU and network provides an efficient system that trains machine-learning models quickly and with low running costs. Ensuring all replicas converge at the same time, improves model accuracy. More accurate models, with faster training times ensures that all NEC businesses and applications such as job recommendations, internet helpdesks, etc. provide more accurate results.

### BRIEF DESCRIPTION OF THE DRAWINGS

FIG. 1 shows an exemplary data center system.

FIGS. 2A and 2B show convergence data of an exemplary workload for MALTall with a single machine workload.

FIG. 3 shows the overall architecture of the system with data and model parameters in one implementation of MALT.

FIG. 4 shows an exemplary method in accordance with the present invention.

FIG. 5 shows an exemplary processing system to which the present principles may be applied, in accordance with an embodiment of the present principles.

FIG. 6 shows an exemplary system where all machines exchange model parameters with equal frequency despite the heterogeneity of bandwidth in a datacenter

FIG. 7 shows an exemplary system that communicates more frequently with machines connected via high bandwidths and occasionally with machines connected over low bandwidths (such as across as rack or a machine boundary).

### DESCRIPTION

Existing data-parallel frameworks have proven to be tremendously useful and popular paradigm for large-scale batch computations, but they are a poor fit for long running ML tasks. ML algorithms such as gradient descent are iterative, and make multiple iterations to refine the output before converging to an acceptable value. ML tasks have the following properties:
Fine-grained and Incremental: ML tasks perform repeated model updates over new input data. Most existing processing frameworks lack abstractions to perform iterative computations over small modifications efficiently. This is because in existing map-reduce implementations, jobs synchronize using the file-system or maintain in-memory copies of intermediate data. For computations with large number of iterations and small modifications, techniques such as these are sub-optimal.
Asynchronous and Approximate: ML tasks that run in parallel may communicate asynchronously. As an example, models that train in parallel may synchronize model parameters asynchronously. Enforcing determinism in the order of parameter updates can cause unnecessary performance overhead. Furthermore, ML tasks may perform computation stochastically and often an approximation of the trained model is sufficient.

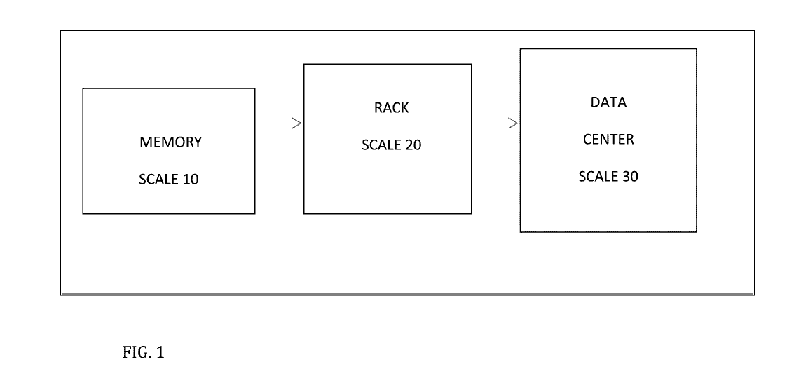

FIG. 1 shows an exemplary data center system using our network aware model consistency for stochastic applications such as machine learning. The system observes following rules when connecting machines in the datacenter:

1. The communication graph of all machines in the data-center is connected (directly or indirectly).

2. All updates are propagated uniformly across the cluster (no update skew).

3. Connections to machine with higher network throughput are preferred over machines with lower network throughput.

FIG. 1 shows our exemplary datacenter setup with three network communication speeds—memory-scale 10, rack-scale 20, and datacenter scale 30. The memory scale operates at memory bandwidth (about 20 GB/s), the rack-scale operates at infiniband or 40G Ethernet speeds (about 5 GB/s) and the datacenter scale operates at switch speeds i.e. around 1 GB/s. Hence, for a given fan-out of every model replica has i replicas in memory, j machines in rack and k racks. Every model replica (i, j, k) communicates with (i+1, j, k), (i, j+1, k) and (i, j, k+1) to satisfy property one. Any additional fan-out edges are first used to connect nodes within the same machine using any uniform random series (such as Halton sequence) and additional edges are connected to machines in decreasing order of throughput (by property 3). The uniform random sequence guarantees property 3.

The system reduces complexity in designing network layout for parallel learning models. It results in reduced cross-datacenter traffic, and it results in faster training since model information from different replicas arrive frequently.

Our embodiment is called MALT (stands for distributed Machine Learning Toolset) that runs existing ML software over a cluster. MALT provides an efficient shared memory abstraction that runs existing ML software in parallel and allows them to communicate updates periodically. MALT exports a scatter-gather API, that allows pushing model parameters or model parameter updates (gradients) to parallel model replicas. These replicas then process the received values by invoking a user-supplied gather function locally. MALT communication is designed using one-sided RDMA writes (no reads for faster round-trip times) and provides abstractions for asynchronous model training. Furthermore, MALT abstracts RDMA programming, and deals with system issues like recovering from unresponsive or failed nodes. The implementation provides a machine learning library that integrates with existing machine learning software and provides peer-to-peer data parallel machine learning. MALT provides abstractions for fine-grained in-memory updates using one-sided RDMA, limiting data movement costs during incremental model updates. MALT allows machine learning developers to specify the dataflow and apply communication and representation optimizations. In our results, we find that MALT provides fault tolerance, network efficiency and speedup to SVM, matrix factorization and neural networks.

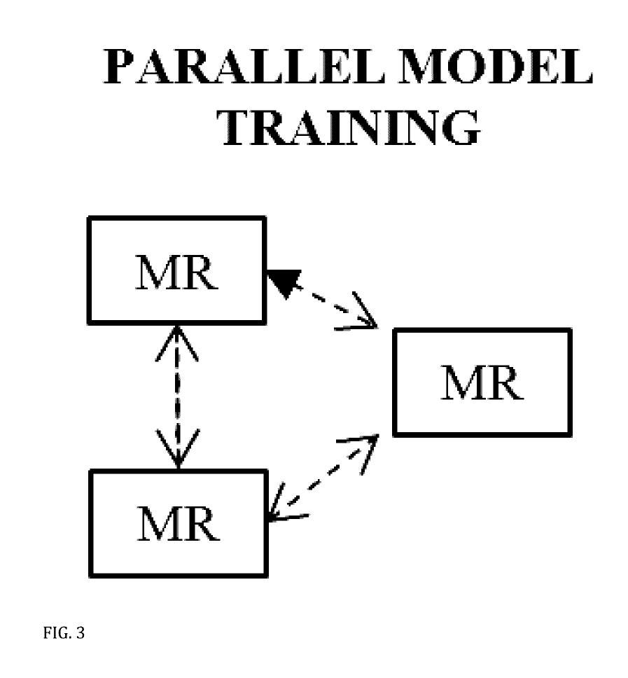

FIG. 3 shows the overall architecture of the system with data and model parameters in our implementation of MALT. In this system, a plurality of model replicas train in parallel using parameter updates. The model replicas train and compute new model weights. They send/receive parameters from everyone and apply them to their own model.

Our data-parallel, peer-to-peer model communication complements the master-slave style parameter server approach. In MALT, parallel model replicas send model updates to one-another instead of a central parameter server. This reduces network costs because the machines only communicate model updates back and forth instead of full models. Furthermore, implementing MALT, does not require writing separate master/slave code or dealing with complex recovery protocols to deal with master failures. We demonstrate that MALT can be used to gain speedup over a single machine for small datasets and train models over large datasets that span multiple machines efficiently.

In MALT model replicas train in parallel on different cores across different nodes using existing ML libraries. ML libraries use the MALT vector library to create model parameters or gradients that need to be synchronized across machines. These vectors communicate over MALT's shared memory abstraction over infiniBand. Furthermore, MALT loads data in model-replicas from a distributed file-system such as NFS or HDFS.

Abstractions for Shared Memory with dstorm MALT's design provides efficient mechanisms to transmit model updates. The system uses RDMA over infiniBand which allows low latency networking of the order of 1-3 micro-seconds by using user-space networking libraries and by re-implementing a portion of the network stack in hardware. Furthermore, the RDMA protocol does not interrupt the remote host CPU while accessing remote memory. Finally, writes are faster than reads since they incur lower round-trip times and MALT exclusively uses writes to implement its shared memory architecture.

We build dstorm (dstorm stands for DiSTributed One-sided Remote Memory) to facilitate efficient shared memory for ML workloads. In MALT, every machine can create shared memory abstractions called segments via a dstorm object. Each dstorm segment is created by supplying the object size and a directed gradient flow graph. To facilitate one-sided writes, when a dstorm segment is created, the nodes in the dataflow synchronously create dstorm segments. dstorm registers a portion of memory on every node with the infiniBand interface to facilitate one-sided RDMA operations. When a dstorm segment is transmitted by the sender, it appears at all its receivers (as described by the dataflow), without interrupting any of the receiver's CPU. We call this operation as scatter. Hence, a dstorm segment allocates space (a receive queue) in multiples of the object size, for every sender in every machine to facilitate the scatter operation. We use per-sender receive queues to avoid invoking the receiver CPU for resolving any write-write conflicts arising from multiple incoming model updates from different senders. Hence, our design uses extra space with the per-sender receive queues to facilitate lockless model propagation using one-sided RDMA. Both these mechanisms, the one sided RDMA and per-sender receive queues ensure that the scatter operation does not invoke the receive-side CPUs and each machine can compute gradients asynchronously.

Once the received objects arrive in local per-sender receive queues, they can be read with a local gather operation. The gather function uses a user-defined function (UDF), such as an average, to collect the incoming updates. We also use queues on the sender side, allowing senders to perform writes asynchronously. We build a vector library over dstorm to expose a vector abstraction over shared memory and to provide additional communication or representation optimizations (such as compression). MALT fault tolerance

Communication efficiency in MALT is detailed next. When MALT is trained using the peer-to-peer approach, each machine can send its update to all the other machines to ensure that each model receives the most recent updates. We refer to this configuration as MALTall. As the number of nodes (N) increases, the gradient communication overhead in MALTall increases O(N 2) times, in a naive all-reduce implementation. Efficient all-reduce primitives such as the butterfly or tree style allreduce may reduce the communication cost. However, this increases the latency by a factor of the height of the tree. Furthermore, this makes recovery complex if the intermediate nodes are affected by stragglers or failures.

In MALT, we propose indirect propagation of model updates. A developer may use the MALT API to send model updates to either all N nodes or fewer nodes k, (1≦k≦N). MALT facilitates choosing a value k such that a MALT replica (i) disseminates the updates across all the nodes eventually; (ii) optimizes specific goals of the system such as freshness, and balanced communication/computation ratio in the cluster. By eventually, we mean that the developer needs to ensure that the communication graph of all nodes is strongly connected as randomly selecting what nodes to send updates to may either result in a partitioned graph of nodes or may propagate updates that may be too stale. This can adversely affect the convergence in parallel learning models and finally (iii) communicates more frequently (and via more machines), the machines that are connected over high bandwidth interconnects.

In MALT we provide a pre-set sequence to ensure uniform gradient propagation. For every node, that propagates its updates to k nodes (k<N), we pick the k node IDs based on a uniform random sequence such as the Halton sequence [1] that generates successive points that create a k-node graph with good information dispersal properties. We further propose that each node only send updates to log(N)) nodes and maintain a log(N)) sized node list. Hence, if we mark the individual nodes in training cluster as 1, . . . , N, Node 1 sends its updates to N/2, N/4, 3N/4, N/8, 3N/8, 5N/8, . . . and so on (the Halton sequence with base 2). Hence, in this scheme, the total updates sent in every iteration is only O(N log N). We refer to this configuration as MALTHalton. FIG. 1 shows the all-to-all and Halton communication schemes.

Using MALT's network-efficient parallel model training results in faster model training times. This happens because 1) The amount of data transmitted is reduced. 2) The amount of time to compute average of gradients is reduced since the gradient is received from fewer nodes. 3) In a synchronized implementation, this design reduces the number of incoming updates that each node needs to wait for, before going on to the next iteration. The key idea with MALTHalton is to balance the communication (sending updates) with computation (computing gradients, applying received gradients). However, the node-graph needs to be strongly connected otherwise the individual model updates from a node may not propagate to remaining nodes, and the models may diverge significantly from one another.

We use MALT to modify SVM-SGD, Hogwild (matrix factorization) and RAPID (neural networks). We perform all experiments on 8 machine cluster. Each machine has an Intel Xeon 2.2 Ghz CPU and 64 GB DDR3 DRAM, connected to one another via a Mellanox Connect-V3 56 Gbps infiniBand. To evaluate SVM, we use RCV1, the PASCAL suite (alpha, webspam, DNA) and splice-site datasets. The compressed training set sizes are RCV1—333 MB (477 MB uncompressed), and splice-site—110 GB (250 GB uncompressed).

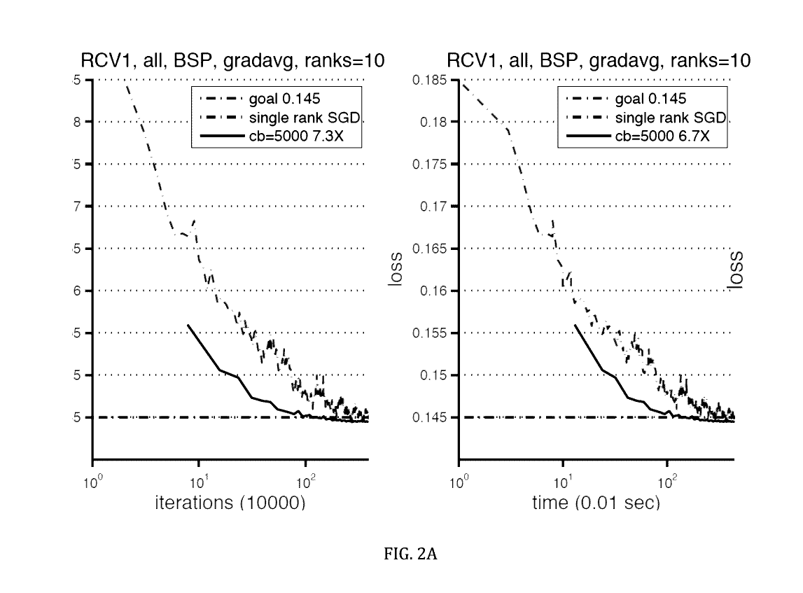

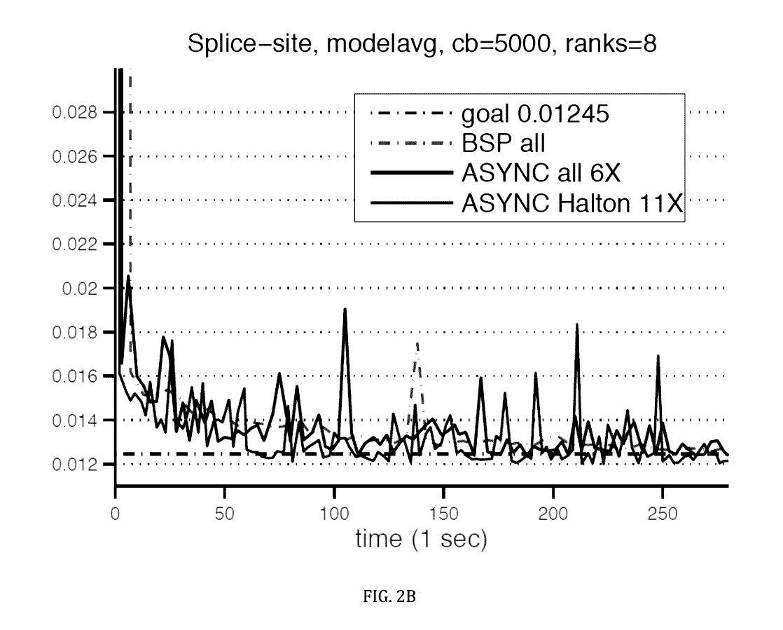

For each of our experiments, we pick the desired final optimization goal as achieved by running a single-rank SGD. FIG. 2A compares the speedup of MALTall for 10 ranks with a single-rank SGD for the RCV1 dataset, for a communication batch size or cb size of 5000. By cb size of 5000, we mean that every model processes 5000 examples and then propagates the model updates to other machines. By 10 ranks, we mean 10 processes, that span our eight machine cluster. For RCV1, we are unable to saturate the network and CPU with a single replica, and run multiple replicas on each machine. We obtain about 6.7× speedup over a single rank performance using MALT.

Next, Network Optimizations results are discussed. FIG. 2B shows the model convergence for the splice-site dataset and the speedup over (Bulk Synchronous Parallelism) BSP-all in reaching the desired goal with 8 nodes. From the figure, we see that MALTHalton converges faster than MALTall. Furthermore, we find that until convergence, each node in MALTall sends out 370 GB of updates, while MALTHalton only sends 34 GB of data for each machine. As the number of nodes increase, the logarithmic fan-out of MALTHalton should result in lower amounts of data sent and faster convergence. MALT Halton trades-off freshness of updates at peer replicas with savings in network communication time. For workloads where the model is dense and network communication costs are small compared to the update costs, MALTall configuration may provide similar or better results over MALTHalton.

Thus, given a list of machines and MALT library, one can parallelize ML algorithms, control the gradient-flow and synchrony. We briefly discuss findings on deploying MALT on our clusters:

Cross-rack reduce: When performing a reduce operation across racks, an all-reduce primitive can be slow. We find that using partial reduce with MALTHalton, that is aware of the underlying rack topolgy can reduce these wait times.

Consistency: Synchronous training is implemented using the barrier construct where workers spend considerable time waiting. Furthermore, barrier gives no information if the recipient has seen or processed the gradient. barrier is also unsuitable for partial reduce (MALT Halton). For these reasons, we provide the notify-ack mechanism, where each receiver acknowledges processing a gradient to the receiver. We find that this gives stricter guarantees than barrier and may improve performance in some cases.

Data Loading: We find that loading data consumes a significant portion of job times. For training tasks with significant CPU times, such as processing image data through deep networks, having a separate data loader that loads and sends data to various workers over infiniBand can be helpful. This allows overlapping data loading with model training, and also removes the initial data load wait times.

InfiniBand support: MALT uses one-sided RDMA primitives that reduces network processing costs and transmission overhead using hardware support. The new generation of RDMA protocols provide additional opportunities for optimizations. Primitives such as fetch and add can be used to perform gradient averaging in hardware and further decrease the model training costs in software.

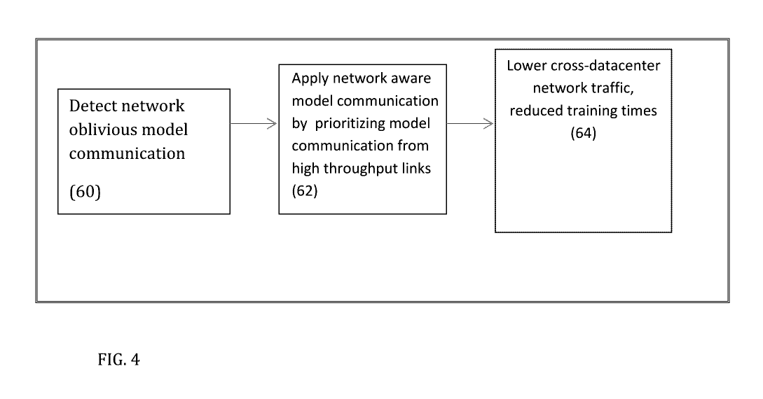

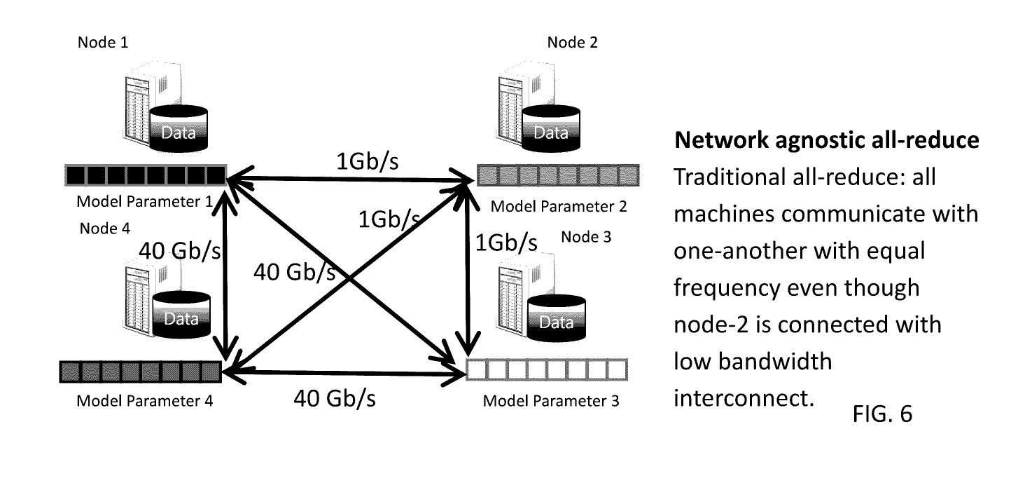

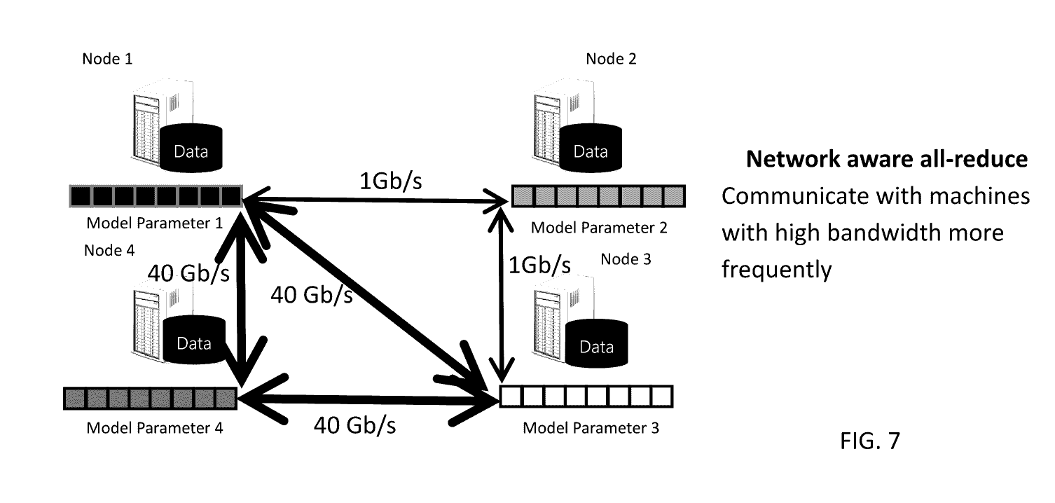

FIG. 4 and FIG. 6 shows an exemplary process to improve learning. First, network oblivious model communication results in high network traffic and slower training (60). Network aware model communication as shown in FIG. 7 is utilized by prioritizing model communication from high throughput links (62). The lower cross-datacenter network traffic improves performance with reduced training times (64).

The distributed training is advantageous in many dimensions: scale, speed, with reduced costs. The distributed systems can handle more data than a single machine can. More disks, more memory, more CPUs, and other resources means that the volume of data is no longer an issue. When data is already distributed, pushing the computation to the data increases scalability. The distributed training is fast as the computation being distributed is inherently compute bound (i.e high CPU usage on all machines), or i/o bound (i.e high disk usage on all machines). In this setting, adding more CPUs and more disks naturally help the cause. The system is economical as it can obtain the same level of performance with a cluster of several low-end computers.

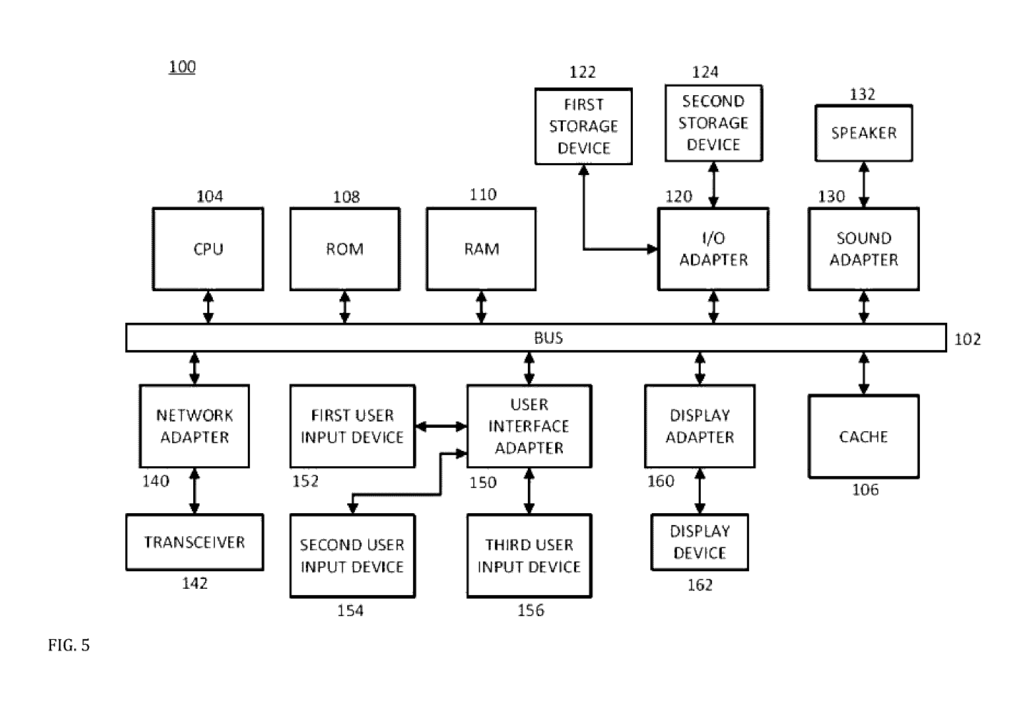

Referring now to the drawings in which like numerals represent the same or similar elements and initially to FIG. 5, an exemplary processing system 100, to which the present principles may be applied, is illustratively depicted in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

It should be understood that embodiments described herein may be entirely hardware, or may include both hardware and software elements which includes, but is not limited to, firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor, e.g., a hardware processor, coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A machine learning method, comprising:
connecting machines in a data-center using a network aware model consistency for stochastic applications;
ensuring a communication graph of all machines in the data-center is connected;
propagating all updates uniformly across the cluster without update; and
preferring connections to a machine with first network throughput over machines with second network throughput smaller than the first network throughput.

2. The method of claim 1, wherein the datacenter comprises with three network communication speeds at a memory-scale, a rack-scale, and data-center scale.

3. The method of claim 2, wherein the memory scale operates at memory bandwidth, the rack-scale operates at infiniband or 40G Ethernet speed and the datacenter scale operates at switch speed.

4. The method of claim 1, for a given fan-out of every model replica with i replicas in memory, j machines in rack and k racks, every model replica (i, j, k) communicates with (i+1, j, k), (i, j+1, k) and (i, j, k+1), wherein additional fan-out edges are first used to connect nodes within the same machine using a uniform random sequence and additional edges are connected to machines in decreasing order of throughput, wherein the uniform random sequence guarantees the preferring of connections.

5. The method of claim 1, comprising training a plurality of model replicas in parallel using parameter updates, wherein the model replicas train and compute new model weights and send or receive parameters from all other model replicas and apply received parameters to their own models.

6. The method of claim 1, comprising:
installing a plurality of model replicas for training on a plurality of computer learning nodes;
receiving training data at a each model replica and updating parameters for the model replica after trailing;
sending the parameters to other model replicas with a communication batch size;
evaluating received parameters from other model replicas; and
dynamically adjusting the communication batch size to balance computation and communication overhead and ensuring convergence even with a mismatch in processing abilities on different computer learning nodes.

7. The method of claim 1, comprising providing MALT (distributed Machine Learning Toolset) that runs existing ML software over a cluster.

8. The method of claim 7, comprising providing a shared memory abstraction that runs existing ML software in parallel and allows the ML software to communicate updates periodically.

9. The method of claim 7, comprising providing a scatter-gather application program interface that allows pushing model parameters or model parameter updates (gradients) to parallel model replicas, wherein the replicas process the received values by invoking a user-supplied gather function locally.

10. The method of claim 7, wherein a MALT communication is performed over one-sided RDMA writes and provides abstractions for asynchronous model training and MALT abstracts RDMA programming, and handles system issues including recovering from unresponsive or failed nodes.

11. The method of claim 1, comprising providing a machine learning library that integrates with existing machine learning software and providing peer-to-peer data parallel machine learning.

12. The method of claim 1, comprising balancing computation and communication in distributed machine learning.

13. The method of claim 1, comprising adjusting the communication batch sizes to automatically balance processor and network loads.

14. The method of claim 1, comprising ensuring accurate convergence and high accuracy machine learning models by adjusting training sizes with communication batch sizes.

15. The method of claim 1, comprising training a plurality of model replicas train in parallel using parameter updates.

16. The method of claim 1, wherein the model replicas train and compute new model weights.

17. The method of claim 1, comprising sending or receiving parameters from all other model replicas and applying the parameters to the current model replica model.

18. The method of claim 1, comprising training on data captured by sensors coupled to an actuator.

19. The method of claim 18, wherein the actuator comprises motor or engine to move a physical object.

20. A machine learning system, comprising:
a data-center using a network aware model consistency for stochastic applications, wherein the network aware model consistency ensures a communication graph of all machines in the data-center is connected, propagates all updates uniformly across the cluster without update, and prefers connections to a machine with first network throughput over machines with second network throughput smaller than the first network throughput;
a plurality of computer learning nodes running a plurality of model replicas for training, each including a processor and a data storage device;
code for receiving training data at a first model replica and updating parameters for the model replica after trailing;
code for sending the parameters to other model replicas with a communication batch size;
code for evaluating received parameters from other model replicas; and
code for adjusting the communication batch size to balance computation and communication overhead and ensuring convergence even with a mismatch in processing abilities on different computer learning nodes.
